(19) United States
(12) Patent Application Publication
(10) Pub. No.: US 2010/0091417 A1
(43) Pub. Date: Apr. 15, 2010

(54) Overvoltage protective device for wind energy installations

(75) Inventor: Heinz-Hermann LETAS, Gross Meinsdorf (DE)

Correspondence Address: MORRISON & FOERSTER LLP, 1650 TYSONS BOULEVARD, SUITE 400, MCLEAN, VA, 22102, US

(73) Assignee: REpower Systems AG, Hamburg (DE)

(21) Appl. No.: 12/569,590

(22) Filed: Sep. 29, 2009

(30) Foreign Application Priority Data
Sep. 30, 2008 (DE) 10 2008 049 630.8

(51) Int. Cl. H02H 7/06; H02H 9/04

(52) U.S. Cl. 361/21; 361/56

(57) ABSTRACT

An overvoltage protective device for wind energy installations is designed for connection to a connecting line having at least one inductance between a wind energy installation and a grid system. The overvoltage protective device has a controller which operates a limiting unit as a function of an overvoltage at the wind energy installation. The limiting unit comprises a spur line having an induction module and a power tapping module which is provided with a switching unit. This yields a second power strand which can accept a considerable reactive current if necessary, thus increasing the voltage drop across the inductance, as a result of which the voltage acting on the wind energy installation is reduced.

### REFERENCE TO RELATED APPLICATIONS

This application claims the priority of German Patent Application No. 10 2008 049 630.8, filed Sep. 30, 2008, the contents of which are incorporated herein by reference.

### FIELD OF THE INVENTION

The invention relates to an overvoltage protective device for wind energy installations, which is connected via an electrical connection having at least one inductance to a grid system, wherein a controller which operates a limiting unit as a function of an overvoltage at the wind energy installation is provided.

### BACKGROUND OF THE INVENTION

The increasingly widespread use of wind energy installations is placing more stringent demands on their response when connected to the grid system. This also applies to the response of the wind energy installations to grid system voltage disturbances, in particular voltage peaks. Until now, wind energy installations have therefore frequently been disconnected for self-protection reasons when voltage peaks occur, but a response such as this is frequently no longer accepted, with regard to grid compatibility. The requirement is for wind energy installations to withstand at least short-term voltage peaks of up to 120% of the grid system voltage. Modern wind energy installations are designed for requirements such as these.

However, the grid operator requirements are not the same in all countries. For example, there are grid operators that specify additional requirements, in particular for tolerance of voltage peaks of up to 140% of the rated voltage. The components of a conventional modern wind energy installation, which are designed for voltage peaks of up to 120%, cannot meet this requirement without matching the components of the wind energy installation to the increased peak voltage. However, this means additional costs. It has therefore been proposed that a wattless-component source be connected into the transmission line, in parallel with the wind energy installation. This wattless-component source, which is also known as Statcom, feeds an additional wattless component when required, and this likewise results in a change in the voltage on the wind energy installation. The Statcom actually needs to be operated only when an overvoltage occurs, so that it has no negative effects on normal operation. However, on the other hand, it is subject to the disadvantage that the procurement and installation costs of a wattless-component source such as this are considerable. It is also known for wattless-component sources with switched capacitors to be provided directly adjacent to wind energy installations in wind farms (U.S. Pat. No. 7,095,597 B1). The capacitors are operated so as to regulate the voltage on the wind energy installation. In contrast to the situation with Statcom, the capacitors are therefore always activated during normal operation, and must therefore be designed to be correspondingly large and robust. This involves a considerable cost outlay.

An entirely different approach to minimizing additional complexity is to quickly disconnect the stator from the grid system when an overvoltage occurs, with the energy stored therein being dissipated in a controlled manner via a substitute load (WO 2004/070936 A1). This offers the advantage that the magnetization in the stator can still be maintained over a certain length of time, as a result of which reconnection can be carried out easily and quickly again after a grid disturbance which lasts for only a short time. Although this approach offers the advantage of only a small amount of additional complexity, it has the disadvantage, however, that the stator must always be disconnected from the grid system when a disturbance occurs.

### SUMMARY OF THE INVENTION

The invention is based on the object of providing an improved overvoltage protective device which avoids the abovementioned disadvantages.

In an overvoltage protective device for wind energy installations, which is designed for connection to a transmission line having at least one inductance between the wind energy installation and the grid system, and having a controller which operates a limiting unit as a function of an overvoltage at the wind energy installation, the invention provides that the limiting unit comprises a spur line having an induction module and a power tapping module which is provided with a switch.

In this case, an induction module means a module which short-circuits the phases or one phase and a neutral conductor via an inductor. The inductor has the characteristic that it has a relatively high short-circuit current, whose phase lags the respective voltage and thus produces an inductive wattless component, to be precise preferably with simple and low-cost passive components in the induction module.

The essence of the invention lies in a combination of the power tapping and provision of an induction module in the branched spur line. Since a preferably rapidly switching switch is arranged in the power tapping module, a second—parallel—power strand can be provided quickly in the event of an overvoltage. Since this temporary parallel power strand is connected to an induction module, this means that a considerable reactive current flows therein. This leads to a voltage drop occurring across the inductance in the transmission line, thus reducing the effective voltage on the wind energy installation when an overvoltage occurs in the grid system. In this case, the low current passes through the induction module during normal operation, which means that no losses occur during normal operation. Since current therefore flows through the induction module only for a short time, it is not loaded thermally in any way during normal operation, and can therefore be very highly loaded in the event of an overvoltage peak, without this leading to thermal overloading.

In this case, the invention makes use of the fact that the wind energy installation has to be tolerant to overvoltage peaks for only a short time. In this case, overvoltage peaks mean those which go beyond the normal range of 120%. The requirements for the tolerance to the full overvoltage peaks at a level of 140% of the rated voltage are therefore restricted to a time period of only a few tenths of a second, with the entire overvoltage peak being maintained over a time period of less than one minute overall in the range above 120% of the rated voltage (which is in fact in any case covered by the design of the components for normal operation in conventional wind energy installations). The merit of the invention is that it has identified the fact that, because of this short time requirement, it is also possible to use components, in this case induction modules which are intrinsically considerably overloaded when the overvoltage peak is applied. Nevertheless, defective components are avoided because the peak is applied for only a short time. The cost advantages of the low design requirements can thus be completely exploited without this leading to disadvantages in terms of operational reliability.

The embodiment according to the invention with a power tapping module and an induction module, which costs little, furthermore offers the advantage that it can easily be matched to different grid connection conditions, by replacement. The induction module can be selected on the basis of the magnitude of the overvoltage peak and the time period over which it must be accepted. The wind energy installation can therefore be matched to the overvoltage peaks by simple replacement of the induction module, for operation in grid systems with entirely different grid connection conditions.

This makes it possible to design the induction module according to the invention to be extremely small, resulting in corresponding cost advantages. The invention therefore combines the advantages relating to good response during operation with low procurement and installation costs. A further advantage of the invention is that it makes use of the inductance, which exists in any case, in the transmission line, for voltage reduction. It can therefore be implemented efficiently and at low cost.

In one preferred embodiment of the invention, the induction module is in the form of a transformer, to be more precise an induction transformer, which is distinguished in that the stray inductance of the transformer is based substantially on magnetic stray fields in the air. These are not subject to saturation. A transformer such as this is therefore particularly suitable for short-circuit operation, since the magnetic circuit does not need to be designed on a more stringent basis, as in the case of inductors based on magnetic cores. This makes it possible to thermally and magnetically overload such transformers to a very major extent, at least for short-term operations. Small, low-cost transformers can therefore be provided for the overvoltage protective device according to the invention. This results in a further advantage of the arrangement according to the invention, specifically that the arrangement in the spur line makes it possible to ignore any no-load losses which may occur, for magnetic design purposes, since no current flows through the transformer during normal operation, because of the spur line.

The switch is preferably in the form of a quick-acting switch. In this case, this means that it switches on within a few milliseconds, that is to say within a maximum of 10 milliseconds. In this case, the switch may be in the form of an intermediate switch. This means that it is arranged between the induction module and the connecting point of the power tapping module to the transmission line. Normally, this arrangement is designed in this way. However, this is not essential, and instead it is also possible to provide, depending on the version of the induction module, for the switch to be in the form of a short-circuiting switch on the module.

The switch is preferably in the form of a thyristor switch, which offers the advantage of a very fast switching speed, which may be 1 ms or less. Bearing in mind the grid system frequency, this means that the thyristor switch switches on with virtually no detectable delay. The thyristor switch is expediently combined with a parallel contactor. This is designed to accept the current from the thyristor switch during longer-lasting operation. In this case, longer-lasting means operation for at least 100 ms. The parallel contactor can also be designed using semiconductor technology, for example with an IGBT, or else to be self-controlling, with a varistor or a Zener diode.

In many cases two thyristors which are provided, arranged back-to-back in parallel, for each phase. It is expedient to arrange switches which are connected back-to-back in parallel in what is referred to here as an economy circuit. This means that the switches are provided in only two of three phases of a three-phase system. The current flow in all three phases can therefore be switched using a smaller number of switches. According to one refined embodiment, switches are arranged in what is referred to here as a super economy circuit. This means that two switches, which are connected back-to-back in parallel, are not interconnected, but that the individual phases are connected to one another by thyristor switches on only one side. This minimizes the number of switches required, while nevertheless safely disconnecting the current.

A further embodiment option for the switches, in particular a configuration as short-circuiting switches, comprises them as a bridge circuit. Six switches can therefore be arranged as a fully controlled bridge, by way of example six thyristor switches as a fully controlled thyristor bridge for short-term operation. A half-controlled bridge can also be provided, for simplicity, in which three switches, instead of six, and three diodes, in addition, are used for a passive rectifier.

The induction module is preferably designed such that it has a short-circuit voltage of about 3 to 7%, preferably 4 to 6%. As a result of the only very short-term load, according to the invention, in the spur line of the power branch, the induction module, which is otherwise completely unloaded, can be considerably overloaded when required. Said design allows twenty five times the power to be applied, at the rated volume, for short-term operation. The aim is to achieve a short-circuit voltage in the range between 4% and 6%, in order to allow use of commercially available transformers. In any case, the induction module is designed such that, without being thermally overloaded, it reduces the maximum voltage peak on the wind energy installation to voltages of at most 120% of the rated voltage, depending on the locally required maximum voltage peak, the time duration of the maximum voltage peak, and/or the local grid impedance.

In many cases, it is sufficient to provide just one induction module, which acts on all the phases. In other cases, it may be advantageous to provide a multistage induction module. A first, a second and possibly a third or further stage is then switched by appropriate switch operation, thus changing the overall effect of the induction module. This allows additional reserves to be created in order to additionally dissipate voltage peaks beyond the expected range. One preferred embodiment for the multistage arrangement is a parallel arrangement. In this case, a plurality of components with staggered ratings and short-circuit voltages in the induction module are each arranged in parallel via their own switching elements. A plurality of stages can be provided by operation of one or more of the switches. A staggered design allows a large number of stages to be achieved (for example, in the case of 4:2:1 design, seven stages can be achieved with only three components). In order to drive it, the controller preferably has multistage logic, which determines the number of stages to be operated, depending on the overvoltage.

The controller advantageously has a repetition module. This is designed to monitor a specific number of operations of the power branch in a rapid sequence within a specific time. If this specific number within the defined time is exceeded, then no further operation takes place, in order to protect the overvoltage device. After a waiting time, which can be regarded as a cooling-down phase, the overvoltage protective device is then once again available. This preferably interacts with an overload module in the controller. This is designed to transmit a monitoring signal to a superordinate regulation unit, which is generally a farm master in a wind farm, in which the wind energy installation that is associated with the overvoltage protective device is located, when the capacity of the overvoltage protective device is exhausted. This situation can occur when the overvoltage is greater than that which can be coped with by the induction module of the overvoltage protective device, or when the repetition module for component protection has been triggered because of a large number of voltage peaks in a short time. The overload module can then be used to ensure that, if a further overvoltage occurs, the relevant wind energy installation is disconnected from the grid system, in order to protect it. Furthermore, a voltage/time characteristic is stored in the overload module and determines the maximum switched-on times as a function of the voltage or the voltage profile of the measurement point. Temperature sensors can also be provided on the induction module, and the overload module monitors the thermal load on the induction module, thus avoiding a critical overload which could lead to damage to the induction module.

The induction module is connected to all the phases of the transmission line. Normally, there is no need to connect it to a neutral conductor. However, this should not be precluded, but a connection can also be provided to the neutral conductor. This is particularly advantageous when the aim is to also compensate for unbalanced voltage faults.

### BRIEF DESCRIPTION OF THE DRAWINGS

The invention will be explained in more detail in the following text with reference to the attached drawings, which illustrate advantageous exemplary embodiments of the invention, and in which:

FIG. 1 shows a schematic view of one exemplary embodiment of an overvoltage device on a transmission line between a wind energy installation and a grid system;

FIG. 2 shows various exemplary embodiments of a power tapping module and an induction module;

FIG. 3 shows various exemplary embodiments with an inductor;

FIG. 4 shows further exemplary embodiments with a transformer;

FIG. 5 shows one exemplary embodiment for switches for the power tapping module;

FIG. 6 shows alternative embodiments for quick-action switches for the power tapping module;

FIG. 7 shows an electrical equivalent circuit of the arrangement shown in FIG. 1; and

FIG. 8 is a diagram showing a grid connection condition relating to overvoltage peaks.

### DETAILED DESCRIPTION OF THE INVENTION

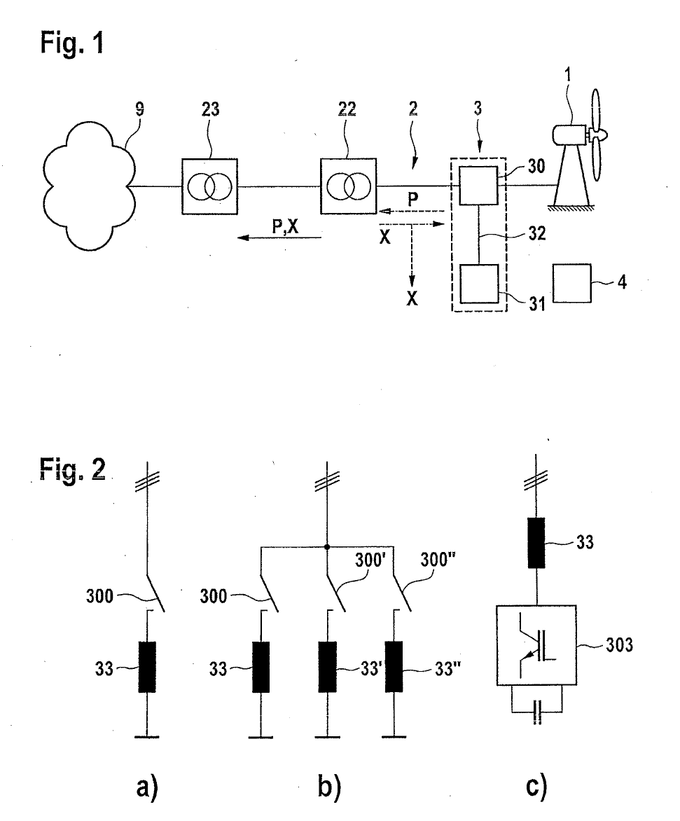

FIG. 1 illustrates a low-voltage wind energy installation 1 connected to a grid system 9. This wind energy installation 1 is connected to the grid system 9 via a connecting line 2 having a medium-voltage transformer 22 and a high-voltage transformer 23. It should be noted that the transformers represent only examples of inductances, as an installation transformer 22 and a farm transformer 23.

An overvoltage protective device, which is annotated in its totality with the reference number 3, is connected to the connecting line 2 between the medium-voltage transformer 22 and the wind energy installation 1, according to one exemplary embodiment of the invention. The overvoltage protective device has a power tapping module 30, from which a spur line 32 branches off, and at its end an induction module 31 is arranged. The solid and dashed arrows indicate power flows during normal operation and in the event of a grid system voltage disturbance. During normal operation, electrical power, to be precise in particular real power as well as an electrical wattless component (which is inductive in over-energized operation), flows from the wind energy installation 1 through the connecting line 2 and the transformers 22, 23 arranged there into the grid system 9 (solid arrow). If an overvoltage occurs in the grid system, then the power flow is reversed, at least with respect to the (inductive) wattless component. Power then flows from the grid system 9 via the transformers 23, 22 through the connecting line 2 to the wind energy installation 1 (under-energized operation). However, according to the invention, the wattless component does not all flow to the wind energy installation 1, but a portion is tapped off via the power tapping module 30 into a spur line 32, from where it is dissipated to the induction module 31. This means that the power flowing through the connecting line 2 is not all passed to the wind energy installation 1, that is to say more wattless component can flow through the connecting line 2 than the wind energy installation 1 can accept. This wattless component flow, which is increased by the power tapping module 30 according to the invention with the induction module 31, results in a greater voltage drop across the transformers 22, 23, as a result of which the voltage at the wind energy installation 1 remains low, even when the voltage in the grid system 9 is high, because of the voltage drop across the transformers 22, 23. The wind energy installation is assumed to be designed for a voltage tolerance of up to 120% of the rated voltage. In addition the exemplary embodiment is required to have a tolerance to overvoltage peaks which may be up to 140%. The magnitude of the overvoltage peaks and the time period during which they must be tolerated by the wind energy installation 1 are illustrated in FIG. 8. Overvoltage peaks up to a maximum level of 140% need be tolerated only over a time period of 100 milliseconds, followed by an overvoltage peak of up to a level only of 125% of the rated voltage over a time period of 2 seconds, following which the overvoltage is reduced to the upper voltage limit value of 120% that is predetermined by the design of the wind energy installation. The limiting unit with the induction module according to the present invention therefore need be activated only briefly during the time period when the voltage is in the range above 120% up to 140% of the grid system voltage, that is to say in total only over a maximum time period of 2 seconds. This overvoltage peak is indicated by the shaded area in FIG. 8. The amount of energy to be accepted and therefore the thermal load on the induction module 31 are governed by this area. An exemplary calculation for the design of the induction module 31 is reproduced in the following text:

Let us assume that a medium-voltage transformer 22 with a rating of 2500 kVA is provided for a wind energy installation with a rating of 2000 kW. If the rated voltage is 690 V and the grid system frequency is 50 Hz, this results in a rated current between the wind energy installation 1 and the medium-voltage transformer 22 of 2092 A. A short-circuit voltage of u_{K}=6% is therefore assumed for the medium-voltage transformer 22. A short-circuit voltage of u_{K}=12% is assumed for the farm transformer 23. When a voltage of 140% of the rated voltage occurs in the grid system 9, the voltage rise in a wind energy installation 1 should be limited to 120% of the grid system voltage, that is to say to a value of 828 V for a rated voltage of 690 V. Overall, it is desirable to reduce the voltage by about 18%, with the intention of dropping about 12% across the farm transformer 23 and about 6% across the medium-voltage transformer 22. In order to achieve this, the overvoltage protective device according to the invention must be designed such that a voltage of 828 V results in a wattless component Q of

\sqrt{3}×828V×2092A=3000kVA

This power flow is tapped off such that a proportion flows from the power tapping module 30 into the spur line 32, which proportion is governed by the ratio of the short-circuit voltage of the medium-voltage transformer 22 to its reactive component in the short-circuit voltage. As stated, the short-circuit voltage in the described exemplary embodiment is assumed to be 4%, 3.87% of which is made up by the reactive component u_{K}. This therefore results overall in a volt-amperes requirement of about 3100 kVA, which must be provided by the induction module 31. For short-term operation, considerable overloading can be accepted because there is virtually no thermal loading during normal operation, to be precise up to the reciprocal of the short-circuit voltage when a short-circuited induction transformer is used as the induction module 31. This therefore results in a continuous volt-amperes load of 124 kVA, by multiplication of the total wattless component as calculated above by the short-circuit factor, finally resulting in a rated current at the increased rated voltage of 86 A.

As can be seen from the example mentioned above, an induction transformer of relatively small design is sufficient for use as the induction module 31 in order to dissipate a high wattless component via the power tapping module 30 into the spur line 32 during short-term operation, thus achieving a considerable voltage drop, across the inductances in the form of transformers 22, 23 in the connecting line 2. In this case, this voltage drop can be chosen to be sufficiently great that the voltage at the wind energy installation 1 has a considerably narrower tolerance band than that in the grid system 9.

FIG. 2 illustrates various embodiment options for the power tapping module 30, with its switch and an induction module 31. These are single-phase equivalent circuits. In the simplest case, just one switch 300 and a grounded induction coil 33 are connected in series with one another (see FIG. 2a). However, it is also possible to provide for a plurality of switches 300, 300′, 300″ and a plurality of induction coils 33, 33′, 33″ to be connected to one another in parallel. The inductances of the short-circuiting inductors 33, 33′, 33″ are preferably chosen to be different to one another, for example with a 4:2:1 split; however, the possibility of the inductances each being of the same magnitude should not be precluded. A staged connection of the short-circuiting inductors 33, 33′, 33″ to the transmission line 2 can then be provided by alternate operation of the switches 300, 300′, 300″. Overall, the various switch positions allow seven combinations. In this case, a suitable reactive current level to be tapped off via the spur line 2 in order to keep the voltage at the wind energy installation 1 within predetermined limits can be defined by operation of the switches 300, 300′, 300″ as a function of the requirement and level of the voltage peak. It should be noted that arrangements with identical short-circuiting inductors can also be provided. FIG. 2c illustrates one alternative embodiment. In this case, the switch for the power tapping module is not arranged between the short-circuiting inductor 31 and the transmission line 2, but down-stream from there in the current flow direction. In this case, one end of the short-circuiting inductor 33 is connected directly to the connecting line 2, and its other end is connected to an inverter 30′. This is connected for short-circuit operation and makes it possible to set different real power levels and wattless components in a manner known per se, depending on the drive level. During normal operation, the inverter 30′ is not operated, as a result of which no current flows through the short-circuiting inductor 33, that is to say the entire power flow passes through the connecting line 2, with none being tapped off. If an overvoltage occurs, the inverter 30′ is operated, as a result of which current is passed through the short-circuiting inductor 33 and a wattless component is therefore tapped off.

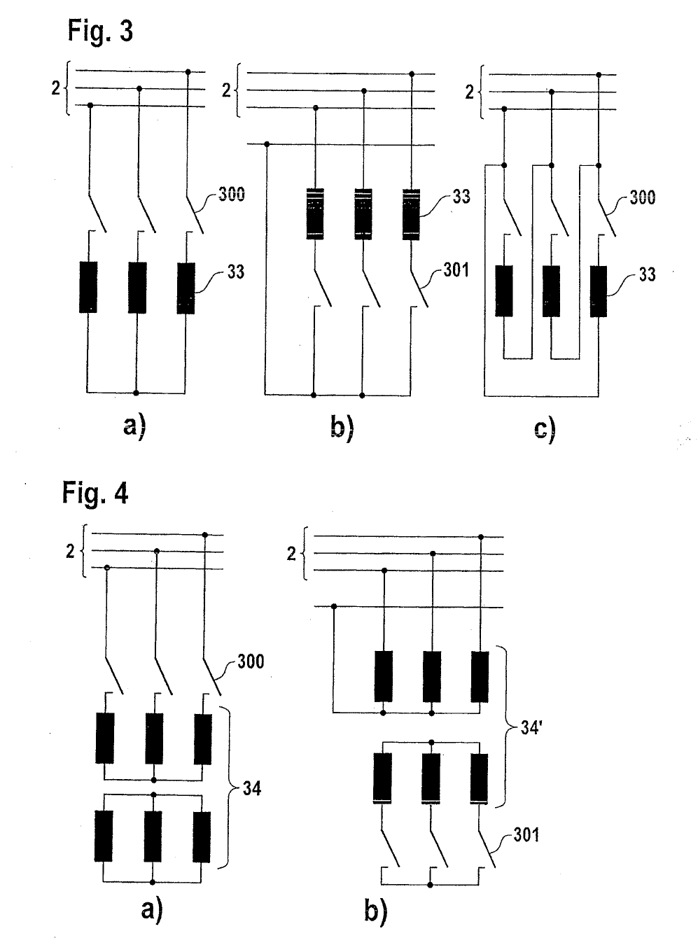

FIG. 3 shows three-phase circuit diagrams for various topologies of power tapping modules 30 and short-circuiting inductors 33. FIG. 3a shows a star circuit without a neutral conductor connection, with the switches 301 for the power tapping module 10 being arranged as intermediate switches. In this case, the expression intermediate switches means that they are arranged between the connecting line 2 and the short-circuiting inductor 33. —FIG. 3b illustrates one alternative topology. This is a star circuit with a neutral conductor connection. The switches 300 are in the form of short-circuiting switches. This means that they short-circuit the short-circuiting inductors 33 in the individual phases to one another at the end remote from the grid system, when required. When the switches are open, then, although the short-circuiting inductors 33 are connected to the connecting line 2, they are not loaded, or are scarcely loaded, however, by their inductance since they are at a floating potential, and are not grounded, at the other end. —FIG. 3c illustrates a further alternative topology. This is a variant of the topology shown in FIG. 3a, to be precise with a delta circuit without a neutral conductor connection. The switches 300 are in the form of intermediate switches. This topology admittedly has the disadvantage that the wiring is more complex, but offers the advantage of lower phase currents in the switches, which has an advantageous effect on the electrical requirements for the switches 300.

FIG. 4 shows exemplary embodiments of the induction module 31 which is a transformer 34 with a short circuit on the secondary side. Transformers 34 such as these are also referred to as “induction transformers”. Use is made in this case of the stray inductance of the transformer 34, based on the magnetic stray fields of the winding, in air. These offer the advantage over the magnetic stray fields in the laminate or magnet core that they are subject to virtually no saturation. Induction transformers 34 such as these therefore do not require an increase in the design requirements for the magnetic circuit for short-circuit operation, as is necessary for inductors based on magnet cores. This allows the induction transformers 34 to be thermally and magnetically very highly overloaded, at least during short-term operation. It is therefore possible to overload an induction transformer 34 with a typical short-circuit voltage of u_{K}=4% with up to twenty five times the power, at the rated voltage. The embodiment illustrated in FIG. 4a has the switch 300 in an intermediate-switch arrangement between the transmission line 2 and the induction transformer 34. This arrangement offers the advantage that, during normal operation, the induction transformer 34 is completely isolated, and therefore causes no losses. With regard to the design of the induction transformer 34, this furthermore offers the advantage that there is no need to consider continuous operation at the rated voltage, since no corresponding no-load losses occur. FIG. 4b shows an alternate embodiment, in which the switch is arranged as a short-circuiting switch 301 in the secondary circuit of the transformer 34′. As already described, the disadvantage of this arrangement is that, in this case, voltage is applied to the transformer 34 during normal operation and therefore that (small) no-load losses occur. However, this arrangement has the advantage that the secondary voltage can in each case be chosen such that it is optimally matched for the short-circuiting switches 300′ to be used. Furthermore, it is possible to standardize the switches to be used as short-circuiting switches 301 for different applications, for example for 690 V for 500 Hz systems, or for 575 V for 60 Hz systems, and to carry out the necessary adaptations via the induction transformer 34′.

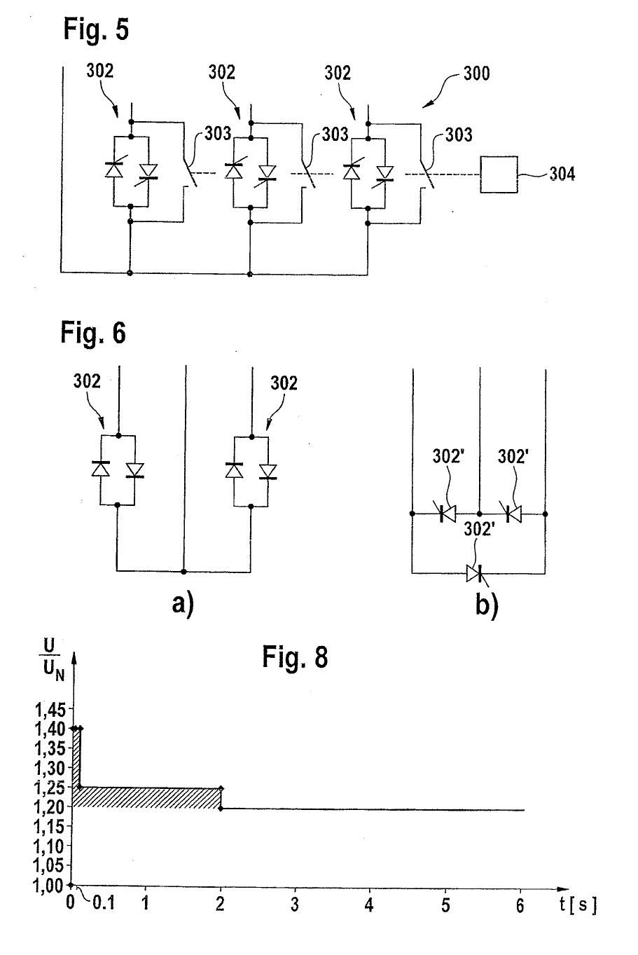

FIG. 5 shows various exemplary embodiments for switches 300 of the power tapping module 30. These are thyristor switches 302 which comprise two thyristors connected back-to-back in parallel. In this case, one pair of thyristors connected back-to-back in parallel are provided for each phase. The control inputs of the thyristor switches 302 are connected to one another, and are driven by a separate controller (not illustrated). Furthermore, FIG. 5 illustrates a parallel contactor 302, which is connected in parallel with each pair of thyristor switches 302. The parallel contactors 303 are functionally operated by a common actuator 304. This is operated by the controller (not illustrated) via a signal line (not illustrated) when relatively long switching times occur, in particular switching times of 100 ms or more.

FIG. 6 illustrates alternative embodiments for the thyristor switches 302. FIG. 6a shows an economy circuit in which a pair of thyristor switches 302, which are connected back-to-back in parallel, are located in only two of the three phases of a three-phase system. No switch is provided in the third phase. The number of switches required is therefore reduced by one third. A further simplification is illustrated in FIG. 6b. This is a “super economy circuit”, in which the thyristor switches 302 are used only once, to be precise in each case connected in delta between the phases with a common orientation direction (FIG. 6b shows rotation counter clockwise, but they could just as well be arranged rotating clockwise as well). This super economy circuit results in a further reduction in the number of switching components required.

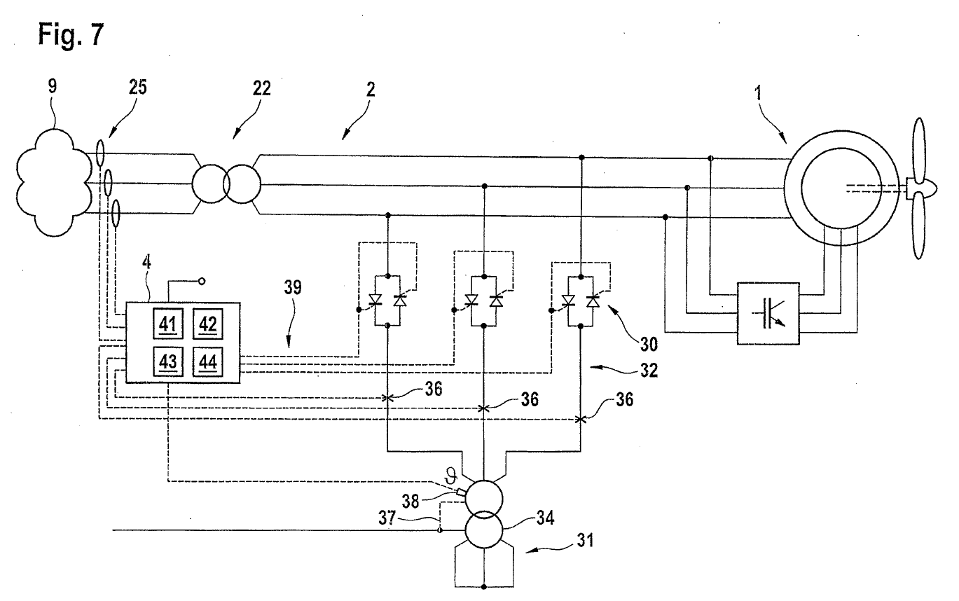

FIG. 7 illustrates a circuit example of the overvoltage protective device according to the invention, which is connected to a grid system 9 by means of a transmission line 2 between a wind energy installation 1 and a medium-voltage transformer 22. The overvoltage protective device comprises a power tapping module 30 and an induction transformer 34 as the induction module 31. The power tapping module 30 has a switch unit in which two thyristor switches, which are connected back-to-back in parallel, are provided for each phase. Furthermore, parallel contactors (not illustrated) can be provided in parallel with the thyristor switches and carry the current over relatively long time periods (considerably more than 100 ms). One side of the switching unit is connected to the transmission line 2, and its other side is connected to the primary side of the induction transformer 37. This is provided in the switching group Yyn0, in which the neutral conductor connection to the primary winding can optionally be provided (shown by dashed lines). Current measurement sensors 36 are arranged for the individual phases in the lines 35 between the switching unit and the primary side of the induction transformer 34. The phase lines are short-circuited to one another on the secondary winding of the induction transformer 34. A neutral conductor connection 37 is also provided.

Voltage sensors 25 are provided on the connecting line 2, both for the low voltage which is present in the wind energy installation and for the medium-voltage level. These are applied as input signals to a controller 4, to which the measurement signals from the current sensors 36 are also connected. The controller 4 determines on the basis of the measured values when an overvoltage situation occurs and emits a switching signal at its output. This is applied via a signal line 39 to control inputs of the thyristor switches of the power tapping module. The thyristors are switched on as a function of the control signal. This is intended for time periods up to about 100 ms. This short time period allows the induction transformer 34 to be considerably overloaded. The following design may be used as the basis for the described induction transformer 34 of the Yyn0 switching group, with a rating of 125 kVA. A short-term wattless component of about 3000 kVA can be accepted in order to reduce the overvoltage acting on the wind energy installation 1 of 140% to the medium-voltage level of 120% at the low-voltage level. A transformer as large as this would be much too expensive for an overvoltage appliance. The invention allows a relatively small induction transformer 34 to be provided, which need be specified only for a rating of about 125 kVA. The invention is based on the knowledge that, because of the short-term operation, the induction transformer 34 can be severely overloaded, to be precise, for example, with the reciprocal of the short-circuit voltage. If the short-circuit voltage is about 4%, its reciprocal is 25. This means that, according to the invention, the induction transformer 34 need be designed for only 125 kVA in order to cope with the required wattless component of 3000 kVA. This allows an extremely small and low-cost induction transformer 34 to be used. The overvoltage protective device according to the invention is therefore compact and small, and costs little. It is therefore particularly suitable for the equipment and for retrofitting of existing wind energy installations.

The controller optionally has multistage logic 41. This is used to carry out the operation dependent on the degree of overvoltage for multistage switches (see FIG. 2b). A repetition module 42 is also provided, and is designed to allow only a specific number of operations successively in a rapid sequence. This avoids the possibility of thermal overloading of the induction module 31 occurring as a result of a plurality of overvoltage situations occurring within a short time sequence. Furthermore, one optional feature is an overload module 43, which transmits a signal to a superordinate control entity, in particular a farm master (not illustrated), when the capacity of the overvoltage protective device according to the invention is exhausted. In this case, there is a risk of the wind energy installation 1 no longer being adequately protected against overvoltage. This is therefore signalled to the farm master, and the relevant wind energy installation 1 can carry out a safety disconnection.

Furthermore, a temperature sensor 38 is connected to the overload module 43 and monitors the temperature of the induction transformer, and possibly of further components such as the switches of the power tapping module 30. When it is found that a critical temperature has been reached, then the overload module 43 emits an appropriate signal, and prevents further operation of the power tapping module 30. Furthermore, the controller 4 contains a characteristic module 44, which contains a voltage/time characteristic. The maximum switched-on times are stored therein as a function of the voltage (see FIG. 8). The controller 4 uses this characteristic module to determine whether the overvoltage peak is still within the intended range, and, if this range is departed from, carries out the safety disconnection, if necessary.

1. An overvoltage protective device designed for connection to a connecting line having at least one inductance between a wind energy installation and a grid system, comprising:
a limiting unit,
a controller which operates the limiting unit as a function of an overvoltage at the wind energy installation,
wherein the limiting unit comprises a spur line having an induction module and a power tapping module which is provided with a switching unit.

2. The overvoltage protective device of claim 1, wherein the switching unit comprises an intermediate switch.

3. The overvoltage protective device of claim 1, wherein the switching unit comprises a short-circuiting switch.

4. The overvoltage protective device of claim 1, 2, or 3, wherein the switching unit comprises semiconductor switches.

5. The overvoltage protective device of claim 4, further comprising an electrically switchable parallel contactor or a motor-operated circuit breaker.

6. The overvoltage protective device of claim 1, wherein the switching unit comprises an economy circuit, having a plurality of switches, the plurality of switches comprising at least one switch less than a number of phases being provided.

7. The overvoltage protective device of claim 6, wherein the plurality of switches are arranged only unidirectionally between the phases.

8. The overvoltage protective device of claim 1, wherein the induction module comprises induction transformer.

9. The overvoltage protective device of claim 8, wherein the induction transformer has a short-circuit voltage of 3 to 7%.

10. The overvoltage protective device of claim 8, wherein the induction transformer is under designed, such that it cannot permanently accept a rated voltage.

11. The overvoltage protective device of claim 9 or 10, wherein the induction transformer is designed such that its rating corresponds approximately to a wattless component which can be accepted for a short time multiplied by the reciprocal of the short-circuit voltage.

12. The overvoltage protective device of claim 1, wherein the induction module has a plurality of stages.

13. The overvoltage protective device of claim 12, wherein the induction module comprises an inductor or transformer with a plurality of taps.

14. The overvoltage protective device of claim 1, further comprising a repetition module which allows a specific number of operations successively in a rapid sequence.

15. The overvoltage protective device of claim 1, further comprising an overload module which uses a superordinate control entity, to signal when the thermal and/or electrical capability of the overvoltage protective device is exhausted.

16. The overvoltage protective device of claim 1, further comprising a characteristic module which implements a voltage/time characteristic and is designed to block on leaving a predetermined operating range.

17. The overvoltage protective device of claim 4, wherein the semiconductors switches comprise at least one of GTOs and IGBTs.

18. The overvoltage protective device of claim 8, wherein the induction transformer has a short-circuit voltage of 4 to 6%.

19. The overvoltage protective device of claim 1, wherein the superordinate control entity comprises a farm master of a wind farm.
